(19) United States
(12) Patent Application Publication
(10) Pub. No.: US 2024/0355312 A1
(43) Pub. Date: Oct. 24, 2024

(54) BIODEGRADABLE ACOUSTIC ATTENUATING MATERIAL AND METHOD OF MAKING SAME

(71) Applicant: SEACORK STUDIO INC., Vancouver (CA)

(72) Inventor: Annie DAHAN, Vancouver (CA)

(21) Appl. No.: 18/642,314

(22) Filed: Apr. 22, 2024

Related U.S. Application Data
(60) Provisional application No. 63/461,499, filed on Apr. 24, 2023.

(51) Int. Cl. G10K 11/165; D21H 17/00; D21H 17/02; D21H 17/66

(52) U.S. Cl. CPC G10K 11/165; D21H 17/02; D21H 17/66; D21H 17/74

(57) ABSTRACT

Biodegradable acoustic attenuating material capable of sound absorption, as well as methods of producing same are provided. The material comprises a mixture composed of dried seaweed powder, a source of fine cellulose fibre and water. Making the material involves mixing all the components into a uniform paste, shaping the paste, and then dehydrating into a solid paste.

This application claims the benefit of U.S. Provisional Application No. 63/461,499, titled ACOUSTIC ATTENUATING MATERIAL AND METHOD OF MAKING SAME, filed on Apr. 24, 2023. The entire content of which is incorporated herein by reference.

### TECHNICAL FIELD

The present disclosure relates to an acoustic attenuating material and method of making same, the acoustic attenuating material being fully regenerative and biodegradable.

### BACKGROUND

The production and life cycle of the majority of construction materials today contribute to environmental degradation and climate change. According to the International Energy Agency Buildings Report in 2023, 13% of annual global carbon dioxide emissions derive from the construction materials of buildings and infrastructure. Furthermore, many construction materials are derived from non-renewable resources such as minerals, metals, and fossil fuels; and the extraction of these resources often involves environmentally damaging practices such as deforestation, habitat destruction, and ecosystem disruption. Construction and demolition activities generate large amounts of waste, much of which is not biodegradable and ends up in landfills for millennia.

Acoustic attenuating materials are widely used in many interior built environments, such as restaurants, classrooms, office spaces, concert halls, etc. The properties of acoustic attenuating materials make for acoustic panels that are soft and porous to absorb and trap sound within the material.

Currently, there are many acoustic attenuating panels on the market, however most are made from environmentally degrading materials such as mineral wool, fiberglass, and polyester foam. For example, mineral fiber panels, like many construction materials, have negative environmental impacts primarily due to their manufacturing processes and end-of-life disposal. Mineral fiber acoustic panels are typically made from mineral wool, which is manufactured by melting minerals such as rock or slag at high temperatures. The production of mineral wool requires significant energy inputs, particularly for the melting and fiberizing processes, contributing to greenhouse gas emissions and environmental degradation. The raw materials used in mineral fiber acoustic panels, such as rock or slag, are often extracted through mining or quarrying operations. These extraction activities can result in habitat destruction, ecosystem disruption, soil erosion, and water pollution, particularly if not conducted sustainably. Some mineral fiber acoustic panels may contain chemical additives or binders to improve performance or fire resistance. These additives can include formaldehyde-based resins or other volatile organic compounds (VOCs), which can off-gas harmful pollutants into the indoor environment, posing health risks to occupants and contributing to indoor air pollution. Mineral fiber acoustic panels are typically non-biodegradable, meaning they do not readily decompose or break down in the environment. Disposal of these panels at the end of their lifecycle can contribute to the accumulation of waste in landfills, creating pollution for millennia, taking up valuable space and potentially leaching harmful substances into the surrounding environment.

Of the few natural acoustic attenuating materials such as wood and cork, these organic matters have very long harvesting cycles—approximately nine years for cork, and over 20 years for wood—and their harvesting is often destructive to their ecosystems.

Accordingly, there is a need for an acoustic absorbing material made of a fast growing organic matter combined with recycled matter, that is low cost, fully regenerative and biodegradable.

Seaweeds are some of the fastest growing organisms known. They photosynthesize, absorbing carbon dioxide (CO2) and releasing oxygen, therefore when seaweeds are used as a material, it is a form of carbon storage potentially resulting in a carbon sink.

Given the rapid growth rate of seaweeds, their ability to function as a natural binder, their sustainable farming potential, and their ability to capture and store carbon—the acoustic absorbing seaweed based material described by this patent makes for a truly environmentally friendly alternative to the synthetic and natural acoustic attenuating materials that are currently on the market.

Several patents and scientific procedures exist for the use of seaweed in bioplastics, aerogels, and construction materials; however, none use a similar process that is described by this patent of combining seaweed with paper to produce an architectural material.

### BRIEF DESCRIPTION OF THE FIGURES

Embodiments of the disclosure will be described by way of examples only with reference to the accompanying drawings, in which:

FIG. 1 is a flow diagram of a method for making an acoustic attenuating material in accordance with an illustrative embodiment of the present disclosure.

FIG. 2 shows an exemplary acoustic panel with surface texture and holes.

FIG. 3 shows an exemplary acoustic disc with surface texture and holes.

FIG. 4 shows a comparison of the acoustic absorbance of a commercial Radar acoustic ceiling panel (made of mineral fiber) and two exemplary acoustic panels according to the present description. The X-axis is sound frequency, and the Y-axis is the acoustic absorption coefficient.

FIG. 5 shows a representation of sound travel through a partition, such as a wall. The solid line arrow represents an incident sound wave, the curvy line arrow represents an absorbed sound wave, and the dashed line arrow represents a reflected or transmitted sound wave.

Similar references used in different Figures denote similar components.

### DETAILED DESCRIPTION

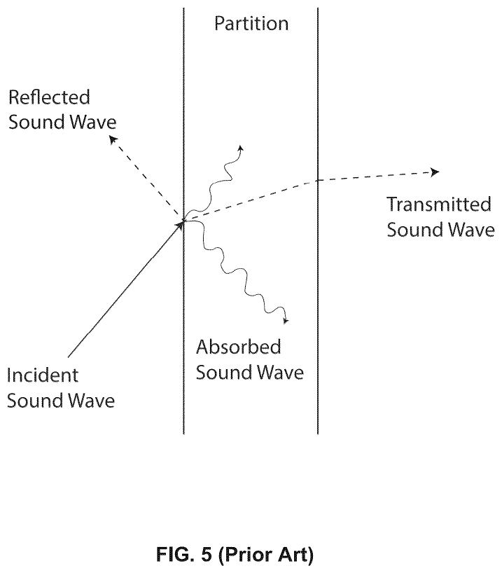

Generally stated, the non-limitative illustrative embodiment of the present disclosure provides an acoustic attenuating material and method of making same, the acoustic attenuating material being fully regenerative and biodegradable. Acoustic attenuation has two aspects: sound insulation and sound absorption which are illustrated in FIG. 5. Sound insulation is designed to prevent sound from entering or leaving a space by blocking sound transmission with dense and heavy materials, making it ideal for environments where sound leakage is a concern. On the other hand, sound absorption aims to improve the acoustic quality within a space by reducing echo and reverberation, using light, porous materials to trap and convert sound waves. While sound insulation focuses on isolation, sound absorption enhances the internal acoustic environment, each serving different purposes in noise control. As used herein, the acoustic attenuating material provided herein has sound absorption properties. In some embodiments, the acoustic attenuating material provided herein has sound insulation properties in addition to sound absorption properties.

The acoustic attenuating material can be cast in a desirable shape and size, and is porous and light. In order to have sound absorption properties, the acoustic attenuating material must have sufficient porosity and lightness. At the same time, in order to be used as an architectural material (such as a panel), the acoustic attenuating material must have sufficient structural integrity. Furthermore, the acoustic attenuating material can be rehydrated and recast several times without losing its materiality, and is compostable.

The acoustic attenuating material is made from three main ingredients: seaweed, such as brown seaweed; paper, such as used low-grade paper diverted from the recycling bin; and water. The resulting acoustic attenuating material absorbs sound at a level similar to that of materials currently used to create architectural acoustic panels, such as mineral fiber, polyester foam, cork, and heavy fabrics. The acoustic attenuating material disclosed therein has a Noise Reduction Coefficient range of 0.5-0.7, depending on variables such as surface texture, fissuring, and thickness.

The term seaweed encompasses a range of macroscopic, multicellular marine algae. Exemplary genus of seaweed include Caulerpa (green algae), Fucus (brown algae), Gracilaria (red algae), Laminaria (brown algae), Macrocystis (brown algae), Monostroma (green algae), Porphyra (red algae), and Sargassum (brown algae). In some embodiments, the acoustic attenuating material is made from brown seaweed. Examples of brown seaweeds that may be used for making the acoustic attenuating material include the Fucus Distichus (Rockweed), the Nereocystis (Bull Kelp), Sargassum, and the Saccharina Latissimi (Sugar Kelp). Seaweeds are some of the fastest growing organisms known. In particular, large brown macroalgae such as Kelp have a particular fast growing speed, making them an ideal seaweed source for manufacturing materials.

Construction materials and composites are generally made up of binders and aggregates. In the case of the disclosed acoustic attenuating material, seaweed is the binder and paper is the aggregate. The present inventor has discovered that seaweed (particularly in the form of powdered seaweed) and paper when combined with hot water are an ideal binder and aggregate, respectively, for making acoustic attenuating material that has sound absorption properties and is sufficiently light yet also has sufficient structural integrity to form an architectural material. The sound attenuation properties and performance of the disclosed acoustic attenuating material are similar to that of the commonly used mineral fiber false ceiling acoustic panels, with the added benefit of being completely biodegradable and sustainably sourced.

Substances that can form a gel (such as a source of alginate, agar, or gelatin) can be used to form natural acoustic attenuating materials. In preferred embodiments, powdered seaweed is used, which in its powdered form results in a more efficient binder. In one embodiment, flaked seaweed is used. The cell walls of brown seaweeds are made up of one part fucan, one part cellulose, and three parts alginate. When the alginate component of seaweeds is mixed with hot water, it creates a gel like binder, holding together the acoustic material, while the other components of the seaweed contribute to the structural integrity of the acoustic attenuating material.

As used herein, the term “paper” refers to any material comprised of fine cellulose fibers. In some embodiments, the disclosed acoustic attenuating material is made of seaweed powder, a source of fine cellulose fibers (such as paper or sawdust), and water. Ideally, paper with minimal additives or coating (such as paper without plastic or wax content) is preferred. Fine cellulose fibers have fiber widths in the micrometer range, or range of a few micrometers to hundreds of micrometers. The aspect ratio (the ratio of fiber length to diameter) impacts the ability of the cellulose fiber to bind with other fibers. The greater the ratio (long fiber and small diameter) the greater the ability of the fibers to bond with each other creating a stronger material. The ideal aspect ratio of a cellulose fiber to make the disclosed acoustic attenuating material is a length in the range of a few millimeters, and a diameter in the range of a few microns. Other exemplary materials or sources having fine cellulose fibers include finely ground sawdust. Finely ground sawdust can be used to make the disclosed acoustic attenuating material, however these fibers usually have a small aspect ratio and can require additional binders such as glycerol to increase the material strength.

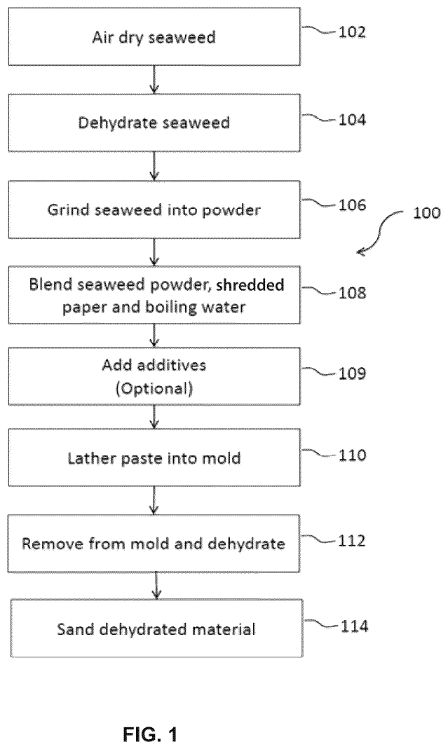

Referring to FIG. 1, there is shown a flow diagram of the method for making an acoustic attenuating material in accordance with an illustrative embodiment of the present disclosure. Steps of the method 100 are indicated by blocks 102 to 114.

The process 100 starts at block 102 where fresh seaweed is dried and dehydrated. Several methods for drying and dehydration are possible (such as air drying, oven drying, freeze drying). The goal is to dry the seaweed enough that it can be crushed into a fine powder. One example of a process is to air-dry the seaweed for 3-7 days in the shade, after which, at block 104, the dried seaweed is dehydrated for 3 hours at 250 F or until it becomes crisp enough that it can be ground into a powder. The length and temperature of dehydration are dependent on the type of seaweed and its moisture content.

At block 106, the baked seaweed is grinded into a powder and, at block 108, the powdered seaweed is blended with shredded low-grade paper, such as paper collected from waste bins, and boiling water. It is to be understood that other types of paper, such as recycled paper may be used. The mixture is one part dry ingredients to at least 3 parts water, or at least 4 parts water, or at least 5 parts water, with the dry ingredients being seaweed powder and paper. The mixture is one part dry ingredients to at most 18 parts water. In one illustrative embodiment, one part dry ingredients to 3 parts water are blended together. The ratios provided herein are calculated in terms of weight. In terms of the dry ingredients, in some embodiments the ratio of seaweed powder to paper are 3:1, 2:1, 1:1, 1:2, 1:3. The mixture is left to blend until it becomes a uniform paste. It is to be understood that there are many different ratios of seaweed, paper, and water that can be used which will give similar results. In one embodiment, one part seaweed powder, two parts paper and 16 parts boiling water are blended together. In another embodiment, two parts seaweed powder, one part paper and 10 parts boiling water are blended together. In one preferred embodiment, one part seaweed powder, one part shredded paper, and 7 parts hot water are blended together.

Optionally, at block 109, additives may be added to the uniform paste from block 108. Alternatively, the additives may be blended together with the powdered seaweed, the shredded low-grade paper, and boiling water at block 108. In preferred embodiments, biodegradable additives are added to change the aesthetics of the material such as color dyes, and scents. For example, ginger or natural scents such as lavender or cedar may be added to neutralize any smell produced by the seaweed. In one example, one part seaweed powder, one part shredded paper, 7 parts hot water, and 0.2 part ginger by weight are blended together at block 108.

In some embodiments, biodegradable additives are added to increase the strength, density and sound insulation qualities of the material, such as clay, crushed eggshells, crushed seashells, and other calcium/calcium carbonate rich substances. In particular, calcium source additives provide structural strength and integrity to the acoustic attenuating material, increasing the acoustic insulation properties.

In order to increase the sound absorption of the material, biodegradable pore-forming agents may be added to the paste at block 109. Examples include baking powder, baking soda, or Epsom salts. For example, 0.3 part baking powder is added for every one part seaweed powder. In some embodiments, about 1-10%, preferably about 3-7%, more preferably about 5% by weight baking powder is added to the mixture. The pore-forming agent allows the paste to expand, increasing the porosity of the final acoustic attenuating material.

In some embodiments, one or more additional binder is added to the paste as additives. Exemplary additional binders include: glycerol, starch, gelatin, gum Arabic, and chitosan to increase the strength and flexibility of the acoustic attenuating material.

Then, at block 110, the paste is lathered into a mold of a desired shape and size and left to sit for about 3 minutes, followed by, at block 112, the removal of the paste from the mold and its dehydration in an oven at 250 F. It is to be understood that the dehydration time will vary depending on the thickness of the mold used and on the required strength and flexibility of the acoustic attenuating material. It is also understood that there are many processes for dehydrating the paste, such as low heat ovens, dehydrators and freeze-drying. In some embodiments, the molded paste is dehydrated to about 80% of its original water content, about 70%, about 60%, about 50%, about 40%, about 30%, about 20%, about 10%, about 5% by weight. In preferred embodiments, 100% of the original water content is removed through dehydration.

In an alternative embodiment, the paste is shaped without use of a mold, such as by hand, into a desired shape and size, followed by dehydration. In another alternative embodiment, the paste is lathered into a mold and at least partially dehydrated in the mold before removing the dried paste from the mold.

In some embodiments, the mold has a depth of 1 cm to 5 cm. After dehydration, the acoustic attenuating material has a thickness of about 0.5 cm to 4 cm, more preferably about 1.5 cm to 2.5 cm, most preferably about 2 cm.

Finally, at block 114, the dehydrated acoustic attenuating material is sanded to get a precise shape and flat edge. This step may also include post processing sub-steps such as laser or machine cutting, laser etching, drilling and/or sewing.

It is to be understood that the various durations and temperatures may vary depending on quantities, types of materials used, types of equipment used, and other conditions such as humidity.

The resulting acoustic attenuating material is capable of sound absorption and has a density in the range of about 60-120 kg/m³, more preferably 80-110 kg/m³, and most preferably about 90 kg/m³. The present inventors have discovered that acoustic attenuating material having the density described herein provides for sufficient lightness or porosity to effectively absorb sound, while also having sufficient integrity to be made into tiles or panels.

### Surface Texture

To further improve sound absorption of the acoustic attenuating material disclosed herein, a surface texture may be introduced. For example, at block 110, the paste is lathered into a mold having textured walls that impart the texture to the surface of the acoustic attenuating material. Alternatively, a textured template is pressed against the molded paste to impart a surface texture.

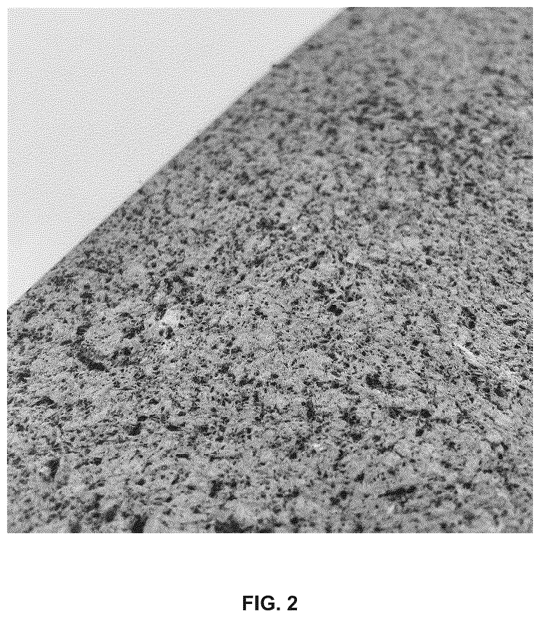

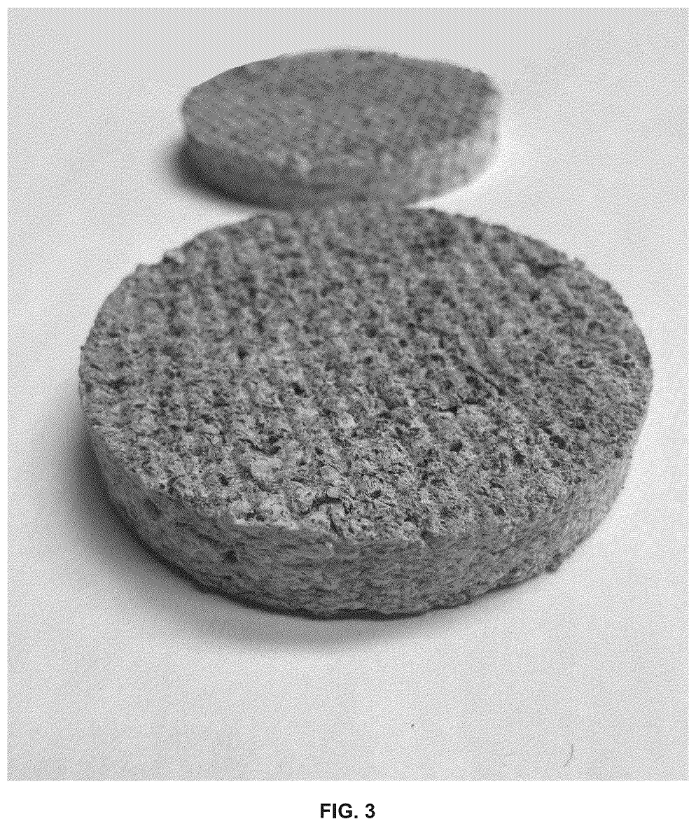

Turning to FIGS. 2 and 3, exemplary acoustic attenuating material is shown having surface textures and surface holes. Exemplary surface textures include a rough porous texture, a wave texture of alternating rows of peaks and troughs, or other surface textures are also possible. In some embodiments, the surface holes are created mechanically. For example, surface holes are created by needling, by introducing spikes to a wall of the mold, or by pressing a template with spikes against the molded paste. The surface holes have a diameter of 2 mm or less, preferably 1 mm or less.

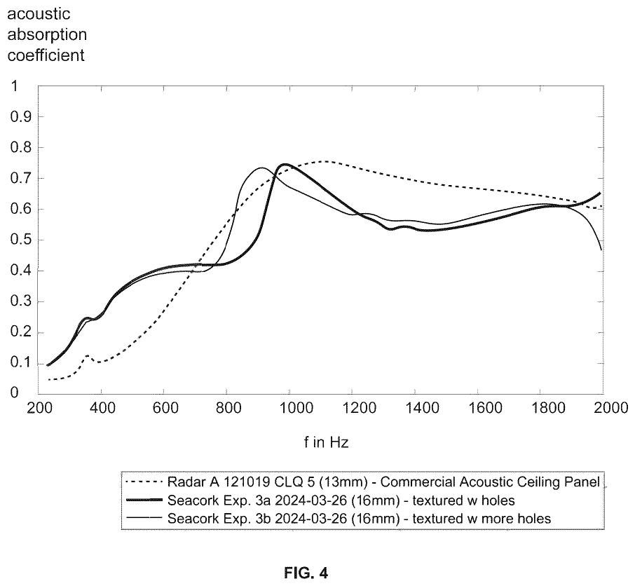

The sound attenuation properties of the acoustic attenuating material with surface texture and holes were compared and tested against commercial acoustic ceiling panels in FIG. 4. The test was performed using an impedance tube and the software AcoustiStudio by AED. The impedance tube is an acoustical apparatus using a two-microphone method as a standard method for measuring the acoustic absorption coefficient of a material according to ASTM E1050-19. For frequencies of around 700 Hz and above, the acoustic attenuating material has comparable sound absorption as compared to a commercial acoustic panel. The acoustic attenuating material also has increased sound absorption for frequencies lower than 700 Hz, which is typically associated with sound insulation. Accordingly, the acoustic attenuating material provides for sound absorption and also partial sound insulation.

### Flame Retardancy

The acoustic attenuating material disclosed herein shows flame retardancy properties as it chars very slowly without creating embers.

It is to be understood that the flame retardancy of the acoustic attenuating material may be adjusted by varying the salt content of the seaweed, the compression force applied to the materials used, the paper ratio and/or by adding a biodegradable fire retardant to the mixture.

### Life Cycle

The acoustic attenuating material is not meant to last forever, like its mineral fiber-based counterparts. It has a circular life cycle, from cradle to cradle. If a panel breaks or is required in a different shape, it can be uninstalled, rehydrated in a blender, and recast to create a new panel over and over again. Once the panel is no longer needed, it can be composted and used as fertilizer. Seaweed is used around the world as fertilizer as it has high levels of cytokinin, a nutrient that promotes cell division and helps plants draw nutrients from the soil.

The farming of seaweed, and specifically sugar kelp, a type of brown seaweed that grows naturally along the coast of British Columbia, Canada, is simple and beneficial to its ecosystem. The sugar kelp is seeded onto a cotton twine rope, laying out the rope on the ocean surface over a sandy soft bottom with no prior seaweed growing and then letting the sugar kelp grow over the winter and harvesting in early summer. The sugar kelp requires no additives such as fertilizers or pesticides to grow, nor does it displace any ecosystems. The farm just needs to be placed in a high salt and nutrient area. As seaweed is photosynthetic, it removes CO2 from the ocean, produces oxygen, and filters the ocean of toxins. Furthermore, as it grows, sugar kelp sheds 50% of its mass, meaning that even though it is being harvested, it provides an equal amount of food for the ecosystem. Also, the sugar kelp provides a nursery habitat for species such as herring to lay eggs on in the spring before the seaweed is harvested. Economically speaking, sugar kelp farming is cheap and requires low initial investments. To put this in perspective, 1 m of rope in a sugar kelp farm produces 1 kg of dry seaweed. The other ingredient, paper, is collected from waste bins and redirected away from landfills or highly intensive water and energy recycling processes.

In comparison to other natural acoustic materials such as wood and cork, sugar kelp is one of the fastest growing organisms on the planet and has a one-year growing cycle. Comparatively, the harvesting of cork has a 9+ year cycle and wood a 20+ year cycle. The acoustic attenuating material is not only sustainable but also regenerative, meaning that it is beneficial to the ecosystem that it becomes a part of.

### Educational Tool

The acoustic attenuating material may also be used as an educational tool in schools to share a different mindset for creating materiality while respecting the environment. Students can be taught to make the acoustic attenuating material step by step, from harvesting the seaweed and learning about the ecosystem it belongs to, to making the acoustic panels that they can then use in their classrooms and eventually compost in their gardens.

### Insulation

The acoustic attenuating material may also be formed in panels having a thickness and size allowing them to be used as thermal insulators.

Although the present disclosure has been described by way of particular non-limiting illustrative embodiments and examples thereof, it should be noted that it will be apparent to persons skilled in the art that modifications may be applied to the present particular embodiments without departing from the scope of the present disclosure as hereinafter claimed.

We claim:

1. A method for producing an acoustic attenuating material capable of sound absorption, the method comprising the steps of:
a) blending a mixture composed of dried seaweed powder, a source of fine cellulose fibre and water to form a uniform paste;
b) lathering the paste into a desired shape and size; and
c) dehydrating the paste into a solid paste, producing the acoustic attenuating material.

2. The method of claim 1, wherein lathering the paste into a desired shape and size comprises lathering the paste into a mold of desired shape and size.

3. The method of claim 1, wherein the acoustic attenuating material has a density of about 60-120 kg/m³.

4. The method of claim 1 further comprising drying seaweed and grinding the dried seaweed into the dried seaweed powder.

5. The method for producing an acoustic attenuating material in accordance with claim 1, wherein in step 1) the blend comprises one part dry ingredients and at least 3 parts water by weight.

6. The method for producing an acoustic attenuating material in accordance with claim 1, further comprising step d) of forming the acoustic attenuating material into a panel via laser cutting, machine cutting, laser etching, drilling or sewing.

7. The method of claim 1, further comprising adding a pore-forming agent to the mixture to increase the porosity of the acoustic attenuating material to enhance acoustic absorption.

8. The method of claim 7, wherein the pore-forming agent is one or more of baking powder, baking soda, or Epsom salts.

9. The method of claim 8, wherein the pore-forming agent comprises about 5% by weight baking powder.

10. The method of claim 1 further comprising blending additives with the mixture composed of the seaweed powder, shredded paper and water to form the uniform paste.

11. The method of claim 10, wherein the additive is one or more of clay, calcium carbonate, powdered eggshells, and powdered seashells for increasing the strength, density and sound insulation qualities of the acoustic attenuating material.

12. The method of claim 10, wherein the additive is a binder comprising one or more of glycerol, starch, gelatin, gum Arabic, and chitosan to increase the strength and flexibility of the acoustic attenuating material.

13. The method of claim 2, wherein the mold comprises a textured wall form imparting a surface texture to the acoustic attenuating material.

14. The method of claim 1, further comprising adding surface holes to the acoustic attenuating material.

15. An acoustic attenuating material capable of sound absorption comprising a dehydrated solid paste, wherein the solid paste comprises a uniform paste made from a mixture composed of seaweed powder, fine cellulose fibre and water, and wherein the acoustic attenuating material has a density of about 60-120 kg/m³.

16. The acoustic attenuating material of claim 15 wherein the mixture comprises one part dry ingredients and at least 3 parts water by weight.

17. The acoustic attenuating material of claim 15 formed into a panel by laser cutting, machine cutting, laser etching, drilling or sewing.

18. The acoustic attenuating material of claim 15, comprising a pore-forming agent.

19. The acoustic attenuating material of claim 18 wherein the pore-forming agent is one or more of baking powder, baking soda, or Epsom salts.

20. The acoustic attenuating material of claim 15, comprising an additive, wherein the additive is one or more of clay, calcium carbonate, powdered eggshells, powdered seashells, dye, a flame retardant, and ginger.

21. The acoustic attenuating material of claim 15 comprising a surface texture.

22. The acoustic attenuating material of claim 15 comprising a plurality of surface holes having a diameter of 1 mm or less.

23. The acoustic attenuating material of claim 15 for use as tiles or panels for ceilings, walls or floors.

24. The acoustic attenuating material of claim 15 for use as a thermal insulator.
